(19) United States
(12) Patent Application Publication
(10) Pub. No.: US 2008/0178699 A1
(43) Pub. Date: Jul. 31, 2008

(54) Check mechanism for shift lever apparatus

(75) Inventor: Katsushi Kubota, Hamamatsu-shi (JP)

Correspondence Address: NATH & ASSOCIATES, PLLC, Sixth Floor, 1030 15th Street, N.W., Washington, DC, 20005, US

(73) Assignee: FUJI KIKO Co., Ltd., Kosai-shi (JP)

(21) Appl. No.: 12/010,125

(22) Filed: Jan. 22, 2008

(30) Foreign Application Priority Data
Jan. 31, 2007 (JP) P2007-021328

(51) Int. Cl. F16H 59/02

(52) U.S. Cl. 74/473.36

(57) ABSTRACT

A check mechanism for a shift lever apparatus includes: a base bracket formed with press-fit holes and locked parts; a shift lever swingably supported by the base bracket; a check member being supported by the shift lever, the check member moving in response to a swing of the shift lever; a check block attached to the base bracket and formed with a check groove; press-fit protrusions provided in the check block being pressed fit into the press-fit holes and having a plurality of ribs on its cylindrical outer periphery; and locking claw parts which being provided in the check block, the locking claw parts being locked to the locked parts formed in the base bracket in a state that the press-fit protrusions being completely pressed fit into the corresponding press-fit holes.

The present disclosure relates to subject matters contained in Japanese Patent Application No. 2007-021328 filed on Jan. 31, 2007, the disclosure of which is expressly incorporated herein by reference in its entirety.

### BACKGROUND OF THE INVENTION

1. Field of the Invention

The present invention relates to a check mechanism for a shift lever apparatus, which allows a driver to feel a detent feeling when the driver operates the shift lever swingingly.

2. Description of Related Art

A shift lever apparatus includes: a base bracket fixed to a vehicle body; and a shift lever swingably supported by this base bracket. On the basis of a position to which the shift lever is shifted, an automatic transmission can change transmission positions. The shift lever apparatus is provided with a check mechanism allowing a driver to recognize whether the shift lever is secured in a shift position, with a detent feeling which the driver feels while the driver is shifting the shift lever.

This check mechanism includes: a cylindrical member supported by the shift lever in an integrated manner; a check member biased by a spring accommodated in this cylindrical member; and a check groove in which the check member slides. The check groove is formed so that a slide resistance working on the check member at each of the shift positions is different from a slide resistance working on the check member between shift positions. This difference in slide resistance allows the driver to feel the detent feeling while the driver is operating the shift lever.

There is an idea that the check groove is provided in the base bracket in an integrated manner. If, however, the check groove is provided in the base bracket in an integrated manner, some parts of the check groove are thicker depending on where the parts are located in the check groove, and what is termed as a “surface sink”, “mold cavity” or “blowhole” occurs while a resin is being molded into the check groove. This brings about a problem that the groove is formed with a poor dimensional precision. In addition, the base bracket is required to be formed of a material having a high rigidity (for example, a synthetic resin containing glass) from a viewpoint that the base bracket needs to securely carry out a function of supporting the slide of the shift lever, whereas the check groove is preferably formed of a material which enables a check member to slide therein smoothly (for example, a synthetic resin containing no glass).

For the purpose of solving this problem, Japanese Utility Model Application, Laid-Open No. Hei. 5-37543 proposes that a check block including a check groove should be formed as a member separate from a base bracket. A check mechanism as recited in the Japanese Publication of Unexamined Utility Model Application includes the check block provided with locking claw parts and the base bracket provided with locked parts, whereby the check block is designed to be attached to the base bracket by simple press fit.

Although the check mechanism of the conventional type for a shift lever apparatus enables the check block to be attached to the base bracket by simple press fit, the mere fitting of the locking claw parts into the locked parts makes it still impossible to attach the check block to the base bracket without causing a backlash in an attachment direction in which the check block is attached to the base bracket, or in a direction orthogonal to the attachment direction. If there is a backlash between the check block and the base bracket, this backlash doesn't allow a driver to feel an adequate detent feeling at any shift position.

### SUMMARY OF THE INVENTION

The present invention has been achieved with such points in mind.

It therefore is an object of the present invention to provide a check mechanism for a shift lever apparatus, which enables a check block to be attached to a base bracket by simple press fit, and even without causing any backlash.

To achieve the object, according to a first aspect of the present invention, there is provided a check mechanism for a shift lever apparatus, which includes: a base bracket which is fixed to a vehicle body, and in which press-fit holes and locked parts are formed; a shift lever swingably supported by the base bracket; a check member which is supported by the shift lever, and which moves in response to a swing of the shift lever; a check block which is attached to the base bracket, and which includes a check groove in which the check member slides; multiple press-fit protrusions provided in the check block, each press-fit protrusion being pressed fit into its corresponding one of the press-fit holes, each press-fit protrusion being shaped like a cylinder, and each press-fit protrusion having multiple ribs on its cylindrical outer periphery; and locking claw parts which are provided in the check block, and which are locked to the locked parts formed in the base bracket with the press-fit protrusions being completely pressed fit in their corresponding press-fit holes.

A second aspect of the present invention is the check mechanism for a shift lever apparatus according to the first aspect, which further includes: supporting parts which are provided in the check block, supporting parts being positioned at locations which are close to shift positions in the check block, and which exist in a surface opposite to a surface in which the check groove is formed; and receiving parts which are provided in the base bracket, receiving parts being positioned at locations abutting on the supporting parts in the base bracket.

A third aspect of the present invention is the check mechanism for a shift lever apparatus according to the first or the second aspect, in which the multiple press-fit protrusions include a reference press-fit protrusion serving as a reference for positioning the check groove to the base bracket, a first press-fit protrusion provided at a location close to the reference press-fit protrusion, and a second press-fit protrusion provided at a location away from the reference press-fit protrusion; ribs are formed on the reference press-fit protrusion; and ribs higher than the ribs formed on the reference press-fit protrusion are formed in the first press-fit protrusion.

A fourth aspect of the present invention is the check mechanism for a shift lever apparatus according to the one aspect among the first aspect to the third aspect, in which the ribs formed on the reference press-fit protrusion are provided respectively at four locations existing at equal intervals in a circumferential direction of the reference press-fit protrusion, whereas the ribs formed on the first press-fit protrusion are provided respectively at four locations existing at equal intervals in a circumferential direction of the first press-fit protrusion.

A fifth aspect of the present invention is the check mechanism for a shift lever apparatus according to the one aspect among the first aspect to the fourth aspect, in which ribs are formed on the second press-fit protrusion at two points at which lines extending in a longitudinal direction of the check block are tangent, and at which the two points face each other.

The first aspect of the present invention allows the press-fit protrusions in the check block to be pressed fit into their corresponding press-fit holes in the base brackets, and concurrently allows the locking claw parts in the check block to be locked to the locked parts in the base bracket, once the check block is pressed fit into its attachment location in the base bracket. In this way, the attachment of the check block to the base bracket is completed. In addition, because the locking claw parts prevent the check block from moving in a direction in which the check block is detached from the base bracket, and because the press-fit protrusions in the check block are pressed fit into their corresponding press-fit holes in the base bracket, the first aspect allows the check block to be attached to the base bracket without causing a backlash in a press-fit direction in which the check block is pressed fit into the base bracket, or in a direction orthogonal to the press-fit direction. As described above, the first aspect enables the check block to be attached to the base bracket by simple press fit, and even without causing a backlash.

The second aspect of the present invention brings about the same effect as the first aspect of the present invention, and additionally makes it possible to prevent, to the maximum extent practicable, the check block from deforming due to a pressing force of a check member working on the check groove, because the check block bears the pressing force at the location of the supporting parts. Particularly because the supporting parts are provided close to the shift positions, the second aspect makes it possible to effectively prevent the check block from deforming in a case where the check member is positioned at a predetermined one of the shift positions for a long time.

The third aspect of the present invention brings about the same effect as the first and the second aspect of the present invention. Additionally, in the third aspect, a dimensional change occurring due to a heat deformation and the like is small at the first press-fit protrusion located close to the reference press-fit protrusion. Moreover, in the third aspect, an expansion occurring due to the heat deformation can be absorbed by an interstice, formed by the ribs, between the first press-fit protrusion and its corresponding press-fit hole. Thus, the check groove can be prevented from being influenced by the deformation and the like. Furthermore, because the ribs on the first press-fit protrusion are set higher than those of the reference press-fit protrusion, in the third aspect, the first press-fit protrusion can undergo a compressive deformation which absorbs a dimensional error more than the reference press-fit protrusion. As described above, in the third aspect, the check block can be pressed fit into the base bracket while the dimensional change and error are absorbed at the location of the first press-fit protrusion. Moreover, because the check block is designed to be attached to the base bracket by using the location of the reference press-fit protrusion as a reference, in the third aspect, the check block can be attached to the base bracket at a proper location.

The fourth aspect of the present invention brings about the same effect as the first aspect to the third aspect of the present invention, and additionally makes it possible to effectively check a backlash between the check block and the base bracket in all the directions orthogonal to the direction in which the check block is pressed fit into the base bracket.

The fifth aspect of the present invention brings about the same effect as the first aspect to the fourth aspect of the present invention. Additionally, a dimensional change occurring due to the heat deformation and the like is large at the second press-fit protrusion located away from the reference press-fit protrusion. Moreover, the dimensional change is observed, to a large extent, in the longitudinal direction of the check block. Furthermore, because the second press-fit protrusion is provided with no ribs on its peripheral surface in the longitudinal direction of the check block, the second press-fit protrusion has a freedom of its movement in the longitudinal direction of the check block. As described above, the fifth aspect makes it possible to press-fit the check block into the base bracket while the foregoing large dimensional change and error are absorbed at the location of the second press-fit protrusion. Moreover, because the check block is designed to be attached to the base bracket by using the location of the reference press-fit protrusion as the reference, the fifth aspect makes it possible to attach the check block to the base bracket at a proper location.

### BRIEF DESCRIPTION OF THE ACCOMPANYING DRAWINGS

The above and further objects and novel features of the present invention will more fully appear from the following detailed description when the same is read in conjunction with the accompanying drawings, in which:

FIG. 1 shows an embodiment of the present invention, and is a side view of a shift lever apparatus;

FIG. 2 shows the embodiment of the present invention, and is a cross-sectional view of the shift lever apparatus taken along the II-II line of FIG. 1;

FIG. 3 shows the embodiment of the present invention, and is an exploded, perspective view of a base bracket and a check block;

FIG. 4 shows the embodiment of the present invention, and a cross-sectional view of the base bracket and the check block taken along the IV-IV line of FIG. 3;

FIG. 5 shows the embodiment of the present invention, and is a perspective view showing an attachment surface of the check block;

FIG. 6 shows the embodiment of the present invention, and is a perspective view showing a check groove in the check block;

FIG. 7 shows the embodiment of the present invention, and a plan view of a reference press-fit protrusion;

FIG. 8 shows the embodiment of the present invention, and a plan view of a first press-fit protrusion; and

FIG. 9 shows the embodiment of the present invention, and a plan view of a second press-fit protrusion.

### DETAILED DESCRIPTION OF PREFERRED EMBODIMENTS

There will be detailed below the preferred embodiments of the present invention with reference to the accompanying drawings. Like members are designated by like reference characters.

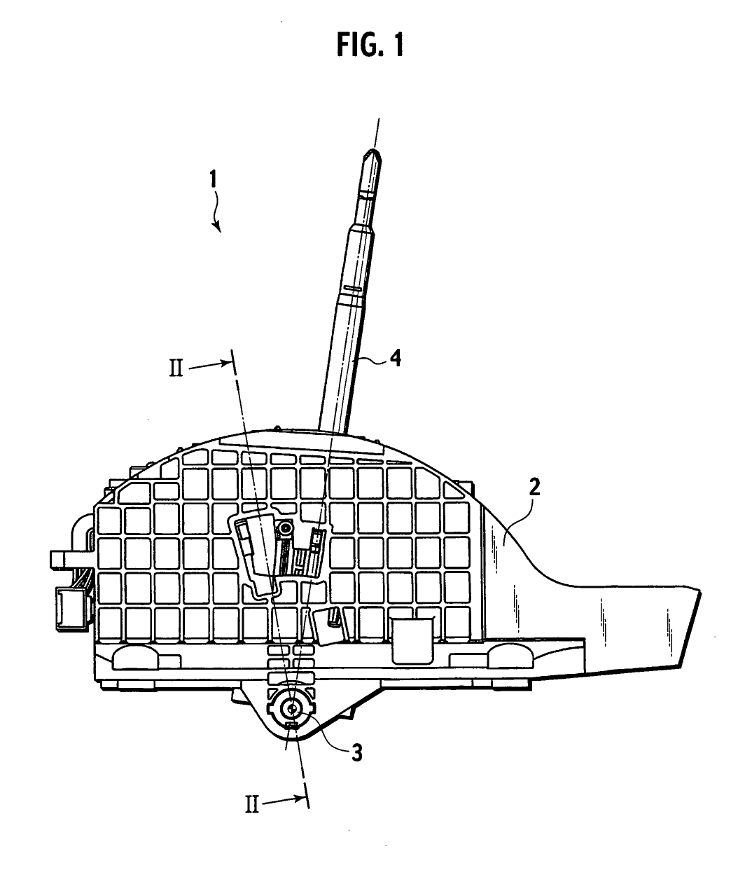

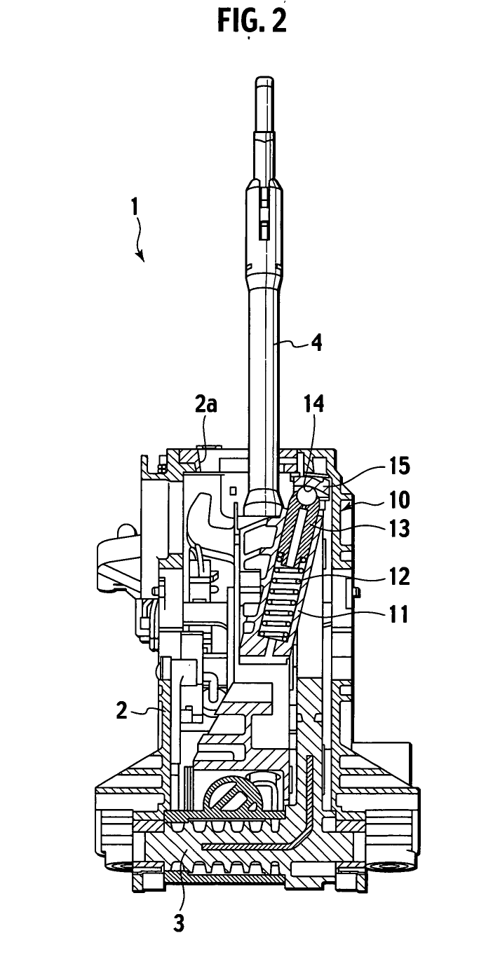

As shown in FIGS. 1 and 2, a shift lever apparatus 1 for an automatic transmission includes: a base bracket 2 fixed to a vehicle body; and a shift lever 4 supported by this base bracket 2 by use of a swing shaft part 3 so that the shift lever 4 can swing in two directions (a shift direction and a select direction) which are orthogonal to each other.

The upper portion of the shift lever 4 juts upwards from a lever guide hole 2a in the base bracket 2. The shift lever 4 is designed to be capable of changing shift positions when a driver swings the shift lever 4 along the lever guide hole 2a by moving a knob (not illustrated) provided to the top of the jutting shift lever 4. The shift positions include: P, R, N, D and L positions arranged in a straight line in the shift direction; and + and − positions arranged in another straight line in the shift direction, which straight line starts at a location departing from the D position in the select direction. Once the shift lever 4 is shifted to each of the shift positions, the shift position is transmitted to the automatic transmission.

As shown in FIGS. 2 to 4, a check mechanism 10 is configured of: a cylindrical member 11, a part of which is fixed to the shift lever 4, and the remaining part of which juts upward diagonally from the shift lever 4; a spring 12 accommodated in this cylindrical member 11; a check member 13 which is biased by this spring 12 in a direction in which the cylindrical member 11 juts upward, and which has a ball at its tip; and a check block 15 which is attached to the base bracket 2, and which includes a check groove 14 in which the check member 13 slides.

The check member 13 slides in the check groove 14 in response to a swing of the shift lever 4. The check groove 14 is formed as a groove where a slide resistance working on the check member 13 at each of the shift positions to which the shift lever 4 is shifted is different from a slide resistance working on the check member 13 between each of the shift positions. Change in operation resistance on the basis of these slide resistances allows the driver to feel a detent feeling while the driver is operating the shift lever 4.

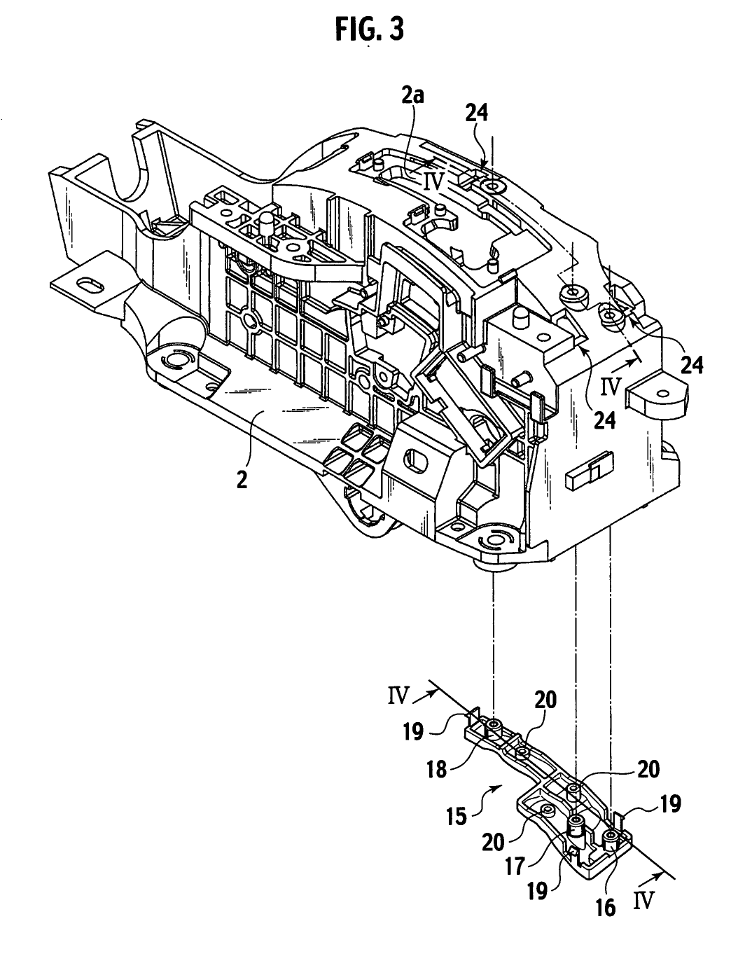

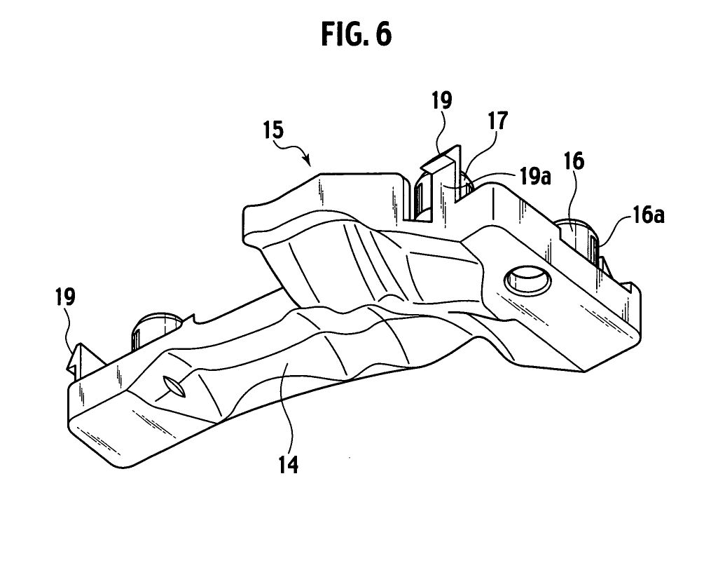

Descriptions will be provided next for a structure for attaching the check block 15 to the base bracket 12. As shown in FIGS. 3 to 6, the check block 15 includes: press-fit protrusions 16, 17 and 18 provided at three locations in the back of the check groove 14, that is, in an attachment surface which is opposite to a surface in which the check groove 14 is formed; locking claw parts 19 provided at three locations in the periphery of the attachment surface; and supporting parts 20 provided at three locations in the attachment surface.

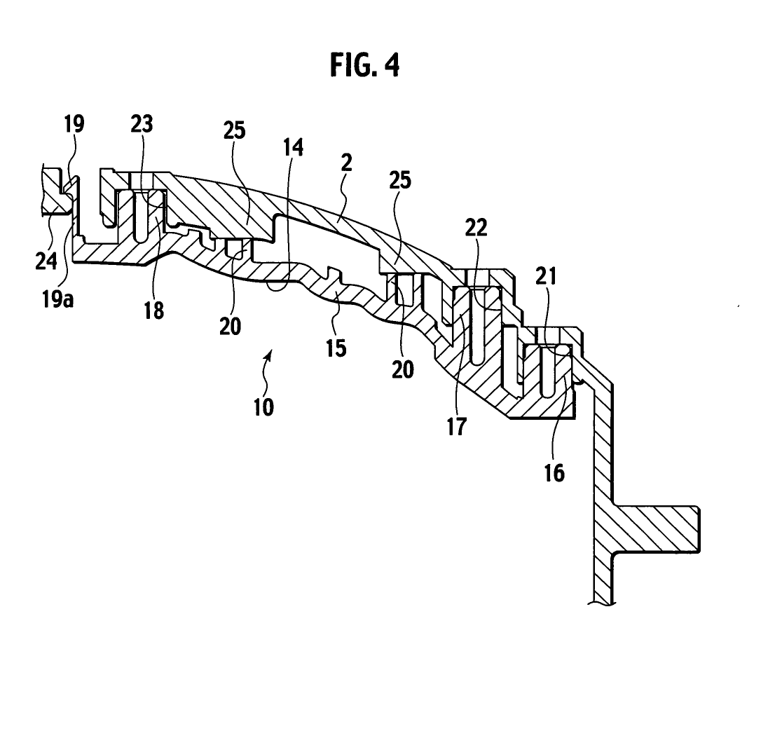

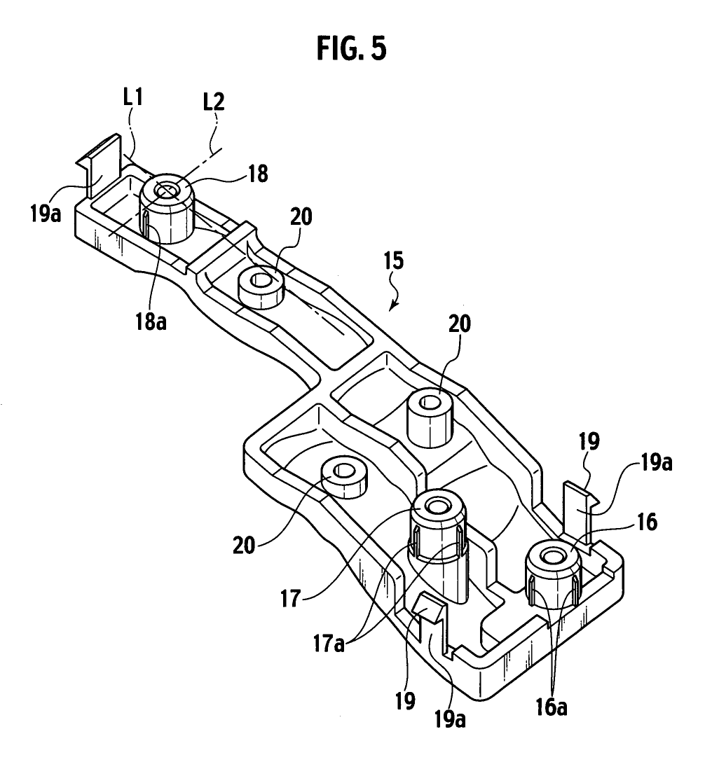

As shown in FIGS. 4 and 5 in detail, the press-fit protrusions 16, 17 and 18 provided at the three respective locations include: a reference press-fit protrusion 16 serving as a reference for positioning the check groove 14 to the base bracket 2; a first press-fit protrusion 17 provided at a location close to this reference press-fit protrusion 16; and a second press-fit protrusion 18 provided at a location away from the reference press-fit protrusion 16 (at an end portion opposite to the reference press-fit protrusion 16 in the check block 15). The press-fit protrusions 16, 17 and 18 are all shaped like a cylinder. The press-fit protrusions 16, 17 and 18 have their multiple ribs 16a, 17a and 18a, respectively. In addition, the number of each of the ribs 16a, 17a and 18a arranged on the press-fit protrusion 16, 17 and 18 is different from one another as follows. Likewise, the height dimension of each of the ribs 16a, 17a and 18a is different from one another as follows.

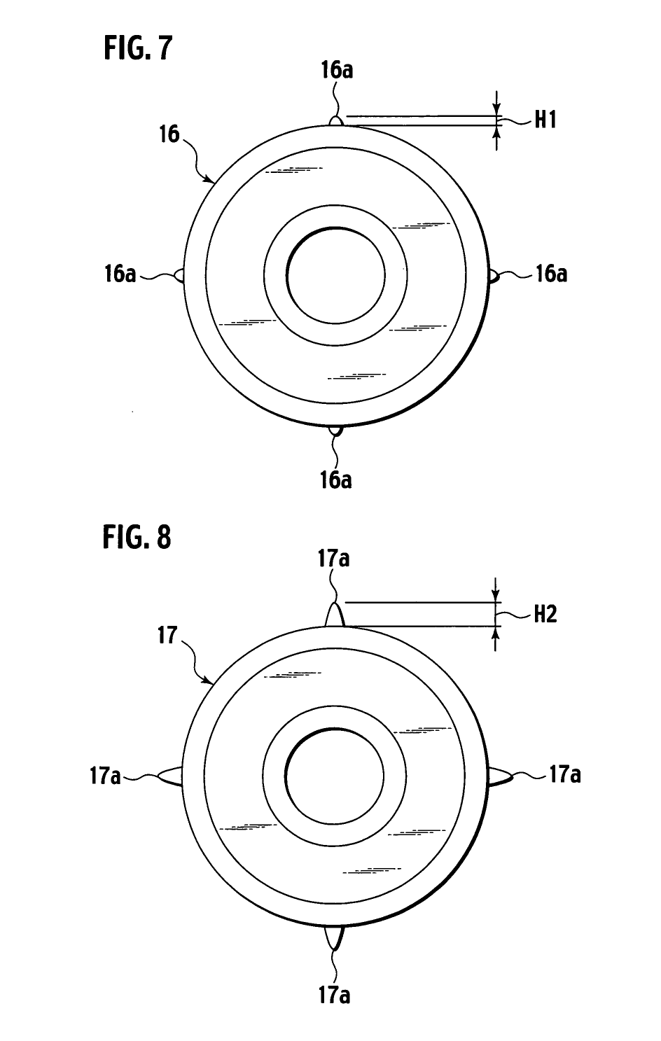

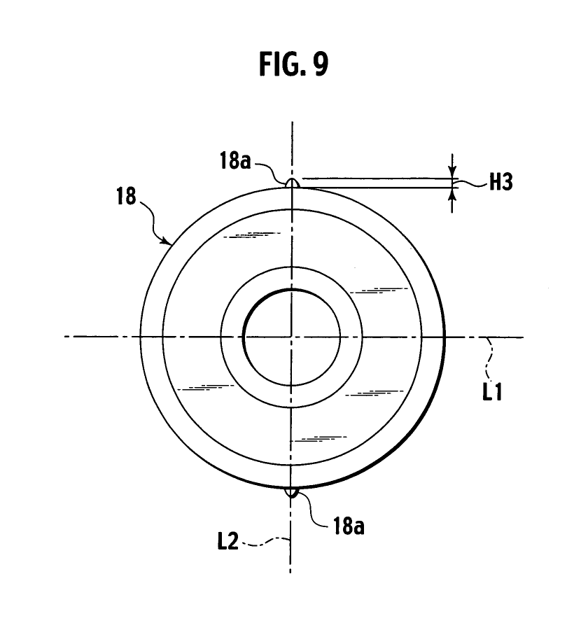

Specifically, as shown in FIGS. 7 and 8 in detail, four ribs 16a and four ribs 17a are provided respectively to the reference press-fit protrusion 16 and the first press-fit protrusion 17 at equal intervals (at each 90 degrees) in their circumferential direction. The height dimension H1 of the ribs 16a on the reference press-fit protrusion 16 is set lower. The height dimension H2 of the ribs 17a on the first press-fit protrusion 17 is set higher than the height dimension H1, because the first press-fit protrusion 17 has a dimensional error larger than that of the reference press-fit protrusion 16. Furthermore, as shown in FIG. 9 in detail, the second press-fit protrusion 18 is provided with no ribs 18a on its peripheral surface at points at which lines extending in an orthogonal direction L2 orthogonal to a longitudinal direction L1 of the check block 15 are tangent, whereas the second press-fit protrusion 18 is provided with the ribs 18a on its peripheral surface at two points at which lines extending in the longitudinal direction L1 of the check block 15 are tangent, and at which the two points face each other. The height dimension H3 of the ribs 18a on the second press-fit protrusion 18 is lower than the height dimension of the ribs 17a on the first press-fit protrusion 17 as in the same manner as the height dimension of the ribs 16a on the reference press-fit protrusion 16.

As shown in FIG. 4, the reference, the first and the second press-fit protrusions 16, 17 and 18 thus configured, which are provided at the three respective locations, are pressed fit into the press-fit holes 21, 22 and 23, respectively. The press-fit holes 21 and 22 into which the reference and the first press-fit protrusions 16 and 17 are pressed fit are formed as circular holes, whereas the press-fit hole 23 into which the second press-fit protrusion 18 is pressed fit is formed as an oval hole whose diameter is longer in the longitudinal direction of the check block 15.

Each of the locking claw parts 19 provided at the three respective locations has a claw which juts outward of the check block 15 from the tip of its arm 19a. The locking claw parts 19 allows the check block 15 to move in the direction in which the check block 15 should be pressed fit into the base bracket 2 by deforming their arms 19a while the check block 15 is pressed fit into the base bracket 2. The locking claw parts 19 are locked to respective locked parts 24 of the base bracket 2 when the press-fit protrusions 16, 17 and 18 are in their corresponding press-fit completion positions where the press-fit protrusions 16, 17 and 18 are completely pressed fit into their corresponding press-fit holes 21, 22 and 23.

The three supporting parts 20 are all shaped like a cylinder, and are arranged in the three respective locations close to the shift positions of the check member 13. The supporting parts 20 abut on the corresponding receiving parts 25 in the base bracket 2 when the supporting parts 20 are in their corresponding press-fit completion positions where the supporting parts 20 are completely pressed fit into the base bracket 2.

Brief descriptions will be provided next for how the check block 15 is attached to the base bracket 2. The check block 15 is inserted into the inside of the base bracket 2 from below. Subsequently, the check block 15 is pressed fit into the attachment location in the base bracket 2. Thereby, the reference, the first and the second press-fit protrusions 16, 17 and 18 of the check block 15 are pressed fit into the press-fit holes 21, 22 and 23. Concurrently, the locking claw parts 19 are locked to their corresponding locked parts 24 when the press-fit protrusions 16, 17 and 18 reach their corresponding press-fit completion locations. In addition, when the press-fit protrusions 16, 17 and 18 reach their corresponding press-fit completion locations, the supporting parts 20 in the check block 15 abut on their corresponding receiving parts 25 in the base bracket 2. The attachment of the check block 15 to the base bracket 2 is completed with this abutment. In other words, the check block 15 can be attached to the base bracket 2 by simply press fit. Because the locking claw parts 19 prevent the check block 15 from moving in a direction in which the check block 15 is detached from the base bracket 2, and concurrently because the reference, first and second press-fit protrusions 16, 17 and 18 are pressed fit into the corresponding press-fit holes 21, 22 and 23 in the base bracket 2, the check block 15 can be attached to the base bracket 2 without causing a backlash in the press-fit direction in which the check block 15 is pressed fit into the base bracket 2 or in a direction orthogonal to the press-fit direction. As described above, the check block 15 can be attached to the base bracket 2 by simple press fit, and even without causing a backlash.

Moreover, because the reference, the first and the second press-fit protrusions 16, 17 and 18 are all shaped like the cylinder, this shape makes it possible to prevent their dimensional change, which occurs due to surface sinks (or mold cavity, or blowhole) as a result of heat shrinkage after the injection molding, to the maximum extent practicable. In addition, because the press-fit protrusions 16, 17 and 18 are capable of deforming toward their internal peripheries while the press-fit protrusions 16, 17 and 18 are pressed fit into the base bracket 2, the press-fit protrusions 16, 17 and 18 can be pressed fit into the base bracket 2 even if the press-fit protrusions 16, 17 and 18 each have some dimensional errors.

In the case of this embodiment, the check block 15 has the supporting parts 20, which abut on the receiving parts 25 of the base bracket 2, near the shift positions of the check member 13. As a result, a pressing force from the check member 13 works on the check groove 14 in the check block 2, and the pressing force is supported at the locations of the supporting parts 20. This makes it possible to prevent the check block 15 from deforming due to the pressing force from the check member 13 to the maximum extent practicable. Particularly because the supporting parts 20 are provided near the shift positions, the deformation of the check block 15 can be effectively prevented in a case where the check member 13 is positioned at a predetermined one of the shift positions for a long time. Furthermore, in the case of this embodiment, because the supporting parts 20 are shaped like the cylinder, this shape makes it possible to prevent their dimensional change, which occurs due to surface sinks as a result of heat shrinkage after the injection molding, to the maximum extent practicable.

In the case of the embodiment, the multiple press-fit protrusions include: the reference press-fit protrusion 16; the first press-fit protrusion 17 provided close to the reference press-fit protrusion 16; and the second press-fit protrusion 18 provided away from the reference press-fit protrusion 16. The height H2 of the ribs 17a on the first press-fit protrusion 17 is set higher than the height H1 of the ribs 16a on the reference press-fit protrusion 16. In this respect, a dimensional change occurring due to heat deformation and the like is small at the first press-fit protrusion 17 near the reference press-fit protrusion 16. In addition, expansion occurring due to the heat deformation can be absorbed by the interstice, formed by the ribs 17a, between the first press-fit protrusion 17 and its corresponding press-fit hole 22. This interstice prevents the check groove 14 from being influenced by the deformation. In addition, the first press-fit protrusion 17 is shaped like the cylinder, and has an interstice inside. This interstice enables the first press-fit protrusion 17 to absorb the expansion which occurs due to the heat deformation. Furthermore, because the height H2 of the ribs 17a on the first press-fit protrusion 17 is set higher than the height H1 of the ribs 16a on the reference press-fit protrusion 16, the first press-fit protrusion 17 is capable of absorbing more dimensional change and error than the reference press-fit protrusion 16. Thereby, this embodiment enables the check block 15 to be pressed fit into the base bracket 2 while the foregoing dimensional change and error are absorbed at the location of the first press-fit protrusion 17. Additionally, because the check block 15 is designed to be attached to the base bracket 2 by using the location of the reference press-fit protrusion 16 as the reference, this embodiment enables the check block 15 to be attached to the base bracket 2 at a proper location.

In the case of this embodiment, the ribs 16a and 17a are provided to the reference and the first press-fit protrusions 16 and 17 at their four locations in their circumferential directions, respectively. This embodiment makes it possible to effectively check the backlash between the check block 15 and the base bracket 2 in all the directions orthogonal to the direction in which the check block 15 is pressed fit into the base bracket 2. It goes without saying that the ribs 16a and 17a may be provided to the press-fit protrusions 16 and 17 at their four or more locations, respectively.

In the case of this embodiment, the second press-fit protrusion 18 is provided with no ribs 18a on its peripheral surface in the longitudinal direction L1 of the check block 15, whereas the second press-fit protrusion 18 is provided with the two ribs 18a on its peripheral surface at the two points in the direction L2 orthogonal to the longitudinal L1 of the check block 15. Here, in this embodiment, a dimensional change occurring due to the heat deformation and the like is large at the second press-fit protrusion 18 located away from the reference press-fit protrusion 16, and the dimensional change is observed, to a large extent, in the longitudinal direction L1 of the check block 15. In addition, because no ribs 18a are provided to the second press-fit protrusion 18 in the longitudinal direction L1 of the check block 15, and concurrently because the press-fit hole 23 is the oval hole, an interstice is formed between the second press-fit protrusion 18 and the press-fit ole 23. As a result, the second press-fit protrusion 18 has a freedom of its movement in the longitudinal direction L1 of the check block 15. For these reasons, this embodiment makes it possible to press-fit the check block 15 into the base bracket 2, while the foregoing large dimensional change is absorbed at the location of the second press-fit protrusion 18. Furthermore, the second press-fit protrusion 18 is capable of absorbing a dimensional error in common with the first press-fit protrusion 17. Moreover, in this embodiment, the check block 15 can be attached to the base bracket 2 at the proper location, because the check block 15 is designed to the base bracket 2 by using the location of the reference press-fit protrusion 16 as the reference. Particularly because the press-fit hole 23 into which the second press-fit protrusion 18 is pressed fit is formed as the oval hole, this embodiment more fully secures the freedom of movement in the longitudinal direction of the check block 15 for the second press-fit protrusion 18 than when the second press-fit protrusion would otherwise be formed as a circle hole. As a result, this embodiment allows the large dimensional change and error to be securely absorbed.

It should be noted that, although the three press-fit protrusions 16, 17 and 18 are provided to the check mechanism for the shift lever apparatus according to this embodiment, the number of press-fit protrusions to be provided to the check mechanism may be two, four or more. Furthermore, although the cross section of each of the ribs 16a, 17a and 18a on the press-fit protrusions 16, 17 and 18 are all shaped like a mountain, the cross section does not have to be limited to this example. The ribs 16a, 17a and 18a provided to the respective press-fit protrusions may be shaped like any other form, such as a rectangle. Moreover, although the supporting parts 20 are provided at the three locations, the number of locations at which the supporting parts 20 are provided may be two, four and more.

Although the invention has been described above by reference to certain embodiments of the invention, the invention is not limited to the embodiments described above. Modifications and variations of the embodiments descried above will occur to those skilled in the art, in light of the above teachings. The scope of the invention is defined with reference to the following claims.

What is claimed is:

1. A check mechanism for a shift lever apparatus, comprising:
a base bracket being to be fixed to a vehicle body, the base bracket being formed with press-fit holes and locked parts;
a shift lever swingably supported by the base bracket;
a check member being supported by the shift lever, the check member moving in response to a swing of the shift lever;
a check block being attached to the base bracket, the check block being formed with a check groove on which the check member slides;
a plurality of press-fit protrusions provided in the check block, each of the press-fit protrusions being pressed fit into its corresponding one of the press-fit holes, each of the press-fit protrusions being shaped like a cylinder, each of the press-fit protrusions having a plurality of ribs on its cylindrical outer periphery; and
locking claw parts being provided in the check block, the locking claw parts being locked to the locked parts formed in the base bracket in a state that the press-fit protrusions being completely pressed fit into the corresponding press-fit holes.

2. The check mechanism for a shift lever apparatus according to claim 1, further comprising:
supporting parts being provided in the check block, the supporting parts being positioned at locations which are close to shifting positions in the check block, and which exist in a surface opposite to a surface where the check groove is formed; and
receiving parts being provided in the base bracket, the receiving parts being positioned at locations abutting on the supporting parts in the base bracket.

3. The check mechanism for a shift lever apparatus according to claim 1, wherein
the plurality of press-fit protrusions include; a reference press-fit protrusion serving as a reference for positioning the check groove to the base bracket; a first press-fit protrusion provided at a location close to the reference press-fit protrusion; and a second press-fit protrusion provided at a location away from the reference press-fit protrusion; and
the ribs formed on the first press-fit protrusion are higher than the ribs formed on the reference press-fit protrusion.

4. The check mechanism for a shift lever apparatus according to claim 3, wherein
the ribs formed on each of the reference press-fit protrusion and the first press-fit protrusion are provided at least at four locations existing at equal intervals in a circumferential direction of the corresponding one of the press-fit protrusions.

5. The check mechanism for a shift lever apparatus according to claim 3, wherein
the ribs formed on the second press-fit protrusion are provided at two points at which lines extending in a longitudinal direction of the check block are tangent, and at which the two points face each other.
